(19) United States
(12) Patent Application Publication
(10) Pub. No.: US 2010/0103420 A1
(43) Pub. Date: Apr. 29, 2010

(54) METHOD FOR THE SPATIALLY RESOLVED MEASUREMENT OF BIREFRINGENCE, AND A MEASURING APPARATUS

(75) Inventors: Ulrich Pahl, Aalen (DE); Jens Spanuth, Aalen (DE)

Correspondence Address: SUGHRUE MION, PLLC, 2100 PENNSYLVANIA AVENUE, N.W., SUITE 800, WASHINGTON, DC, 20037, US

(73) Assignee: Carl Zeiss SMT AG, Oberkochen (DE)

(21) Appl. No.: 12/604,670

(22) Filed: Oct. 23, 2009

(30) Foreign Application Priority Data
Oct. 24, 2008 (DE) 10 2008 043 158.3

(51) Int. Cl. G01J 4/00

(52) U.S. Cl. 356/365

(57) ABSTRACT

A method for the spatially resolved measurement of the birefringence distribution of a cylindrically symmetrical blank (2) made from an optical material transparent to at least one wavelength λ_{B} between 180 nm and 650 nm, in particular at 193 nm, including: irradiating the blank (2), arranged in a container (4) with an immersion fluid (5), at a jacket-side measurement position (MP) using a measuring light beam (9) which runs in a measuring direction (Y) preferably perpendicular to the axis of symmetry (S) of the blank (2), as well as varying the jacket-side measurement position (MP) by moving the measuring light beam (9) and the blank (2) relative to one another in two directions (X, Z) perpendicular to the measuring direction (Y) for the purpose of spatially resolved measurement of the non-axial birefringence distribution of the blank (2).

The following disclosure is based on German Patent Application No. DE 10 2008 043 158.3, filed on Oct. 24, 2008, which is incorporated into this application by reference.

### BACKGROUND OF THE INVENTION

The invention relates to a method for the spatially resolved measurement of the birefringence distribution of a cylindrically symmetrical blank made from an optical material transparent to at least one wavelength λ_{B} between 180 nm and 650 nm, in particular at 193 nm, as well as to a measuring apparatus for carrying out the method.

Projection exposure machines for microlithography are usually operated at wavelengths below 250 nm, for example with pulsed lasers at an operating wavelength of, for example, 248 nm (KrF laser) or 193 nm (ArF laser). The birefringence of the optical material plays an important role in the case of the optical elements used in such machines, in particular in the case of lens elements. Birefringence designates the splitting of the incident radiation into two component beams (ordinary or extraordinary beam), which are polarized in a fashion perpendicular to one another and to the propagation direction and have different propagation speeds, and can be caused by stresses in an optical material. The axis with the higher propagation speed is also designated as the “fast axis”.

Owing to the different propagation speeds, the two component beams have a phase shift after passing through the optical material. When such optical elements are used in optical installations operated with polarized radiation, for example in illumination systems operated in a polarized fashion, it is possible for there to occur stress-induced polarization losses which in the case of an illumination system, for example, may make it difficult to produce a sharply delimited and homogeneously illuminated image field.

In order to determine the “stress” birefringence (SBR) of optical elements before their installation in an optical system and, if appropriate, to introduce measures for their compensation, it is known to measure the stress birefringence of the blank from which the optical element is fabricated along the axis of symmetry, corresponding substantially to the light passage direction, of the cylindrical blank wafer (Z-direction). In this method, a mean stress birefringence distribution (for example in nm/cm) integrated over the thickness of the blank in the Z-direction is obtained in an axial direction (Z-direction), as is illustrated in FIG. 1a by way of example. FIG. 2a shows a statistical evaluation of the absolute value of the birefringence distribution of FIG. 1a with the histogram of the absolute value of the birefringence in the limits between 0 nm/cm and approximately 1 nm/cm. In order to measure the birefringence distribution shown in FIG. 1a, use is made of measuring instruments, operating, for example, with measuring radiation at a measuring wavelength of 633 nm (He—Ne laser), and transilluminates the blank with a measuring light beam which is received by a spatially resolving detector in conjunction with variation of the rotation angle of an analyzer, as described in U.S. Pat. No. 5,257,092 for example.

Investigations have shown that the spatially resolved measurement of the axial stress birefringence (SBR) of a blank is not sufficient in every case to adequately qualify the polarization behavior of the optical element fabricated from the blank. This problem occurs, in particular, wherever there is produced from the blank an optical element which is operated with a light passage direction which deviates from the axial direction, that is to say in the case of which individual beams have an angular deviation from the axial direction of, for example, more than 5°.

### OBJECT OF THE INVENTION

It is an object of the invention to provide a method for the spatially resolved measurement of the birefringence distribution of a blank, as well as a measuring apparatus with the aid of which it is possible to model the total stress behavior of the blank.

### SUMMARY OF THE INVENTION

This object is achieved by a method of the type mentioned at the beginning, comprising: irradiating the blank, arranged in a container with an immersion fluid, at a jacket-side measurement position by means of a measuring light beam which runs in a measuring direction preferably perpendicular to the axis of symmetry of the blank, as well as varying the jacket-side measurement position by moving the measuring light beam and the blank relative to one another in two directions perpendicular to the measuring direction for the purpose of spatially resolved measurement of the non-axial birefringence distribution of the blank.

It is proposed according to the invention to measure the birefringence of the blank in a spatially resolved fashion at the cylindrical lateral surface thereof, in order to obtain the non-axial birefringence distribution, also spatially resolved in the Z-direction, of the blank. To this end, it is possible to use the measuring light beam, which is produced as a rule by the light source of a polarimeter, to scan the lateral surface of the blank such that it is possible to measure the birefringence distribution in the XZ plane of the blank in the case, for example, of a measurement carried out in the Y-direction.

In an advantageous variant, the method further comprises: irradiating the blank at an end-face measurement position by means of a measuring light beam, which runs in an axial measuring direction parallel to the axis of symmetry of the blank, as well as varying the end-face measurement position by moving the measuring light beam and the blank relative to one another in two directions perpendicular to the axial measuring direction for the purpose of spatially resolved measurement of the axial birefringence distribution of the blank. The measured values, determined in this way, of the axial birefringence distribution can be combined with the measured values of the non-axial birefringence distribution in order to model the total stress behavior of the blank, that is to say the three-dimensional distribution of the birefringence in the blank, as well as to determine the effect thereof on the polarization. It is possible in this way to estimate the polarization behavior of the optical element to be fabricated from the blank, and to determine the total influence thereof on the polarization behavior of the optical system in which the optical element is to be integrated.

It is preferred to determine the orientation of the fast axis of the birefringence in the blank from the (non-axial and/or axial) birefringence distribution. This is possible because the high quality phase information can be provided with the aid of the commercially available polarimeters. The orientation of the fast axis in this case supplies important information relating to the type of retardation of the radiation in the blank (tangential or radial, which is important for compensations of the stress-induced retardation effects—see “Correction of the phase retardation caused by intrinsic birefringence in deep UV lithography” SPIE 5754-194 2005-01-31 or U.S. Pat. No. 6,844,972 B2).

In a variant, the measuring light beam has a measuring wavelength of less than 250 nm, in particular of 193 nm, and an immersion, fluid is selected which has an extinction coefficient of less than 2×l/cm at the measuring wavelength. When use is made of a measuring light source which produces measuring light at a wavelength in the UV region, for example a lamp with a bandpass filter or in the case of a suitable laser, the measurement can be performed with the same wavelength as the operating wavelength (for example 193 nm) of the customary stepper and scanner systems for microlithography in which the blank is to be used.

It is necessary here to select an immersion fluid which still has a sufficient transmission even at UV wavelengths. Such an immersion fluid (decahydro-2-trifluoromethyl-2,3,3-trifluoro-1,2:5,8-dimethanonaphthalene), which has an extinction of approximately 1.2 l/cm, is known from U.S. Pat. No. 7,084,314, which is incorporated in the content of this application by reference. However, straight-chain perfluorinated polyethers (for example, CF3-(O—CF2-CF2)ₓ-(O—CF2)_{y}-O—CF3-) which have an extinction of approximately 1.8 l/cm at 193 nm, are also suitable as immersion fluids.

The data obtained about a blank which has an intrinsic birefringence at the measuring wavelength, for example a blank made from calcium fluoride (CaF₂) at a wavelength of 193 nm, must in this case be corrected by the contributions of the intrinsic birefringence (compare J. Burnett, Z. H. Levine, E. L. Shirley and J. H. Bruning in: J. Microlithography, Microfabrication and Microsystems1 (2002) 213).

In a preferred variant, the refractive index of the immersion fluid is selected such that it (virtually) corresponds to the refractive index of the optical material of the blank at the measuring wavelength. The above described decahydro-2-trifluoromethyl-2,3,3-trifluoro-1,2:5,8-dimethanonaphthalene, which has a refractive index of 1.555 at this wavelength, is suitable for calcium fluoride as a material of the blank which has a refractive index of approximately 1.50 at 193 nm for example. However, even the abovedescribed straight-chain perfluorinated polyethers, which have a refractive index of 1.527 at a wavelength of 193 nm, are suitable as immersion fluids for calcium fluoride.

In an advantageous variant, in a previous step the influence of the immersion fluid and of the container in the measurement of the birefringence of the blank is determined for correction purposes. To this end, the container with the immersion fluid without a blank arranged in it, at least in the region in which the blank is to be measured subsequently, is scanned with the measuring light beam of the polarimeter in order to determine the retardation, produced by the immersion fluid and the container (cuvette) and the phase shift. The values, produced by the immersion fluid and cuvette, of the birefringence and phase shifts is subtracted from the polarimetric data (the associated value of the birefringence and the phase information) determined during the measurement of the blank. As has been shown in the case of measurements on a double blank, this subtraction should be performed in vector fashion, that is to say in addition to the absolute value it is also necessary to take account of the phase information of the birefringence.

In a further advantageous variant, in order to determine the non-axial birefringence of the blank, the path length covered in the blank by the measuring beam is determined at the respective jacket-side measurement position. Since, because of the round geometry of the blank, the path length covered by the measuring beam in the blank is dependent on the distance of the measuring light beam from the central plane of the blank, the measured values at different measurement positions have to be normalized in order to be able to compare them. This normalization is performed by dividing the value, measured by the polarimeter, of the birefringence, by the path length covered. It is possible hereby to determine the birefringence at each measurement position as the retardation per unit of length (for example in [nm/cm]).

In a variant, during the relative movement the blank is moved in common with the container. As the container, typically a cuvette, moves, the speed of the displacement movement must be adapted suitably in order to prevent the immersion fluid from spilling over. Another possibility of preventing spilling over is a tightly sealing lid.

In a particularly advantageous variant, the measuring light beam is produced by a measuring light source and is detected by a detector and during the relative movement the measuring light source is moved in common with the detector. The measuring light source and the detector together form a polarimeter, it being possible to provide the detector with an evaluation device in order to process the measured measurement data. As the light source and measuring head move, the scanning speed during the displacement movement can be selected in accordance with the stipulations of the manufacturer of the polarimeter, since in this case the container is stationary and therefore it is impossible for the immersion fluid to spill over during the movement. It goes without saying that spilling over can be prevented even in the case of the movement of the container during use of a tightly closing lid.

In a particularly preferred variant, calcium fluoride is selected as optical material of the blank. In addition to other materials such as, for example, synthetic silica glass, synthetic calcium fluoride is used in microlithography as lens material for optical elements, since it has a high transmission in the UV wavelength region.

The invention is also implemented in a measuring apparatus for carrying out the abovedescribed method, comprising: a container, in particular a cuvette, filled with an immersion fluid (transparent, for example, in the wavelength region from 180 nm to 650 nm), a blank made from an optical material transparent to at least one wavelength λ_{B} between 180 nm and 650 nm, in particular at 193 nm, a polarimeter for irradiating the blank with a measuring light beam at a jacket-side measurement position, a measuring direction of the polarimeter running preferably perpendicular to the axis of symmetry of the blank, as well as a movement device for moving the polarimeter and the container relative to one another in two directions perpendicular to the measuring direction in order to vary the jacket-side measurement position for spatially resolved measurement of the non-axial birefringence distribution of the blank. Such a measuring apparatus can be used to perform the above-described method particularly effectively. When carrying out the method, it is necessary to ensure that there is sufficient immersion fluid present between the wall, which is transparent to the measuring radiation at least in the region measured, of the container or the cuvette, and the blank, otherwise excessively high values result for the stress birefringence (edge effects). There is likewise a need for the immersion fluid to surround the entire blank so that no surface effects can corrupt the measurement.

In an advantageous embodiment, the movement device is designed for moving the or a further polarimeter and the container relative to one another in two directions perpendicular to the axis of symmetry of the blank. In order to measure the birefringence in an axial direction, the measuring apparatus can have a further polarimeter, if appropriate, the measurement can also be carried out with a single polarimeter, for example if the movement device can be used to rotate the light source and the detector by 90°. It goes without saying that both the axial and the non-axial measurement of the birefringence distribution can also be carried out by changing the orientation of the blank in the cuvette, for example by providing in the cuvette a holder for the blank that is shaped such that the blank can be aligned with its axis of symmetry both parallel and perpendicular to the measuring direction. Here, the change in orientation of the blank in the holder is usually undertaken manually. Alternatively, it is also possible to firmly seal the container with a cover and to rotate it by 90°.

The refractive index of the immersion fluid should correspond as well as possible to the refractive index of the optical material of the blank at the measuring wavelength, such that the measurement can be conducted without a polished surface of the blank and in a fashion independent of the angle (total reflection). The abovedescribed immersion fluids can serve this purpose in the case of a blank made from calcium fluoride, for example.

In a further embodiment, the polarimeter has a measuring light source for producing the measuring light beam preferably at a measuring wavelength of less than 250 nm, in particular at 193 nm, as well as a detector for detecting the measuring light beam, and which are located opposite one another in the measuring direction. The measuring light source produces a measuring light beam (linearly) polarized as a rule, at a constant orientation of the polarization vector, and the detector measures the rotation of the polarization vector by using a rotatable polarizer to determine the intensity of the radiation striking the detector after passing through the blank. The measuring wavelength can deviate here from the operating wavelength, at which the optical element fabricated from the blank is operated, and, for example, lie in the visible region, for example at 633 nm. However, it is also possible to select the measuring wavelength to be in the UV wavelength region below 250 nm and, in particular, to be equal to the operating wavelength (for example 193 nm) of the customary stepper and scanner systems for microlithography.

The immersion fluid preferably has an extinction coefficient of less than 2.0×l/cm at the measuring wavelength, in order to ensure as high a transmission as possible of the measuring light beam during passage through the immersion fluid.

In an advantageous embodiment, the blank has a thickness of more than 40 mm. The thicker the blank, the more intense are the polarization losses caused by the birefringence in the case of radiation which is not incident parallel to the axis of symmetry.

Further features and advantages of the invention emerge from the following description of exemplary embodiments of the invention, with the aid of the figures of the drawing, which show details essential to the invention, and from the claims. The individual features can in each case be implemented individually per se or severally in any desired combination for a variant.

### BRIEF DESCRIPTION OF THE DRAWING

Exemplary embodiments are illustrated in the diagrammatic drawing and are explained in the following description. In the drawing:

FIGS. 1a,b show diagrammatic illustrations of an embodiment of a measuring apparatus for measuring the birefringence at a blank, in two side views,

FIGS. 2a,b show diagrammatic illustrations of the end-face or the jacket-side birefringence distribution at the blank of FIGS. 1a,b,

FIGS. 3a,b show diagrammatic illustrations of histograms of the birefringence distributions of FIGS. 2a,b as a function of the absolute value of the measured birefringence, and

FIGS. 4a,b show diagrammatic illustrations of the orientation of the fast axis of the birefringence in the blank measured in an axial or non-axial direction.

### DETAILED DESCRIPTION OF EXEMPLARY EMBODIMENTS

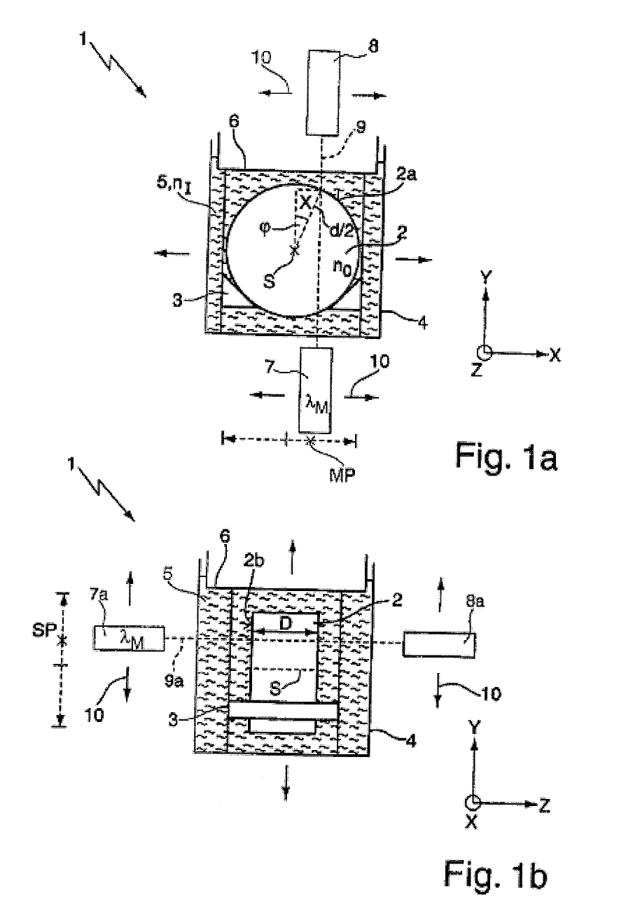

FIGS. 1a,b show diagrammatically a measuring apparatus 1 for the spatially resolved measurement of the birefringence distribution of a cylindrically symmetrical blank 2 made from synthetic calcium fluoride which is transparent to radiation at the operating wavelength λ_{B} of an optical element to be fabricated from the blank 2. It goes without saying that it is also possible to measure blanks made from other material, for example from silica glass, with the aid of the measuring apparatus 1. The blank 2 is arranged in a holder 3 in a container 4 formed as a cuboid cuvette. The container 4 is filled with an immersion fluid 5 which completely surrounds the blank 2. Both a cover 6, which delimits the immersion fluid 5 above, and the wall of the container 4 consist of a material transparent to VUV and visible radiation, for example of silica glass.

The measuring apparatus 1 further has a polarimeter 7, 8 which consists of a measuring light source 7 and a detector 8 which are arranged opposite one another along a measuring direction Y of an XYZ coordinate system. A polarized measuring light beam 9 produced with a measuring wavelength λ_{M} of 633 nm or 193 nm by the measuring light source 7, which is designed as a He—Ne laser or as a 193 nm light source, preferably as a laser, irradiates the blank 2 as its lateral surface 2a at a measuring position MP which is defined by the X-coordinate and the Z-coordinate of the XYZ coordinate system. The measuring light beam 9 which has penetrated through the blank 2 is captured by the detector 8 in order to measure the rotation of the polarization direction of the measuring light beam 9, and to determine the birefringence of the blank at the measurement position MP (jacket-side measurement position) from the polarimetric measured data thus obtained.

In conjunction with a stationary container 4, the measuring light source 7 and the detector 8 can be displaced in the XZ-plane (measuring plane) by means of a movement device 10, for example, indicated by arrows, which can be designed in the form of conventional linear drives. Alternatively, the movement device 10 can also be designed such that it enables the container 4 to be displaced with the blank 2 (compare the arrows in FIG. 1a). However, in this case the displacement speed is limited, if appropriate, since it is necessary to prevent the immersion fluid 5 from spilling over out of the container 4. Spilling over can also be prevented by having the cover 6 close the container 4 sealingly. The movement of the polarimeter 7, 8 in the X-direction and Z-direction enables a variation of the measuring position MP in the XZ-plane, and thus scanning of the measurement field, and therefore the spatially resolved measurement of the distribution of the stress birefringence in the blank 2 in the non-axial direction, that is to say perpendicular to its axis of symmetry S.

In order to determine the birefringence distribution, it is, however, necessary firstly to correct the polarimetric measured data, which are obtained from the measurement of the blank 2 in the container 4 filled with the immersion fluid 5, by the polarimetric measured data of the container 4 filled with the immersion fluid 5 without the blank 2. The subtraction of the measured data should be performed here in vector fashion, as shown with the aid of double measurements at the blank 2.

If the aim is to measure at a measuring wavelength of 193 nm, it is advantageous to correct the absolute values and phases obtained by the absolute value, caused by the intrinsic birefringence of the blank, and phase.

In order to ensure the comparability of the measured data at various measurement positions (MP) there is, furthermore, a need to correct the measured data with reference to the path length which the measuring light beam 9 covers in the blank 2, since the blank 2 has a cylindrical geometry. The stress birefringence value (SBR) obtained at the respective measurement position MP is therefore corrected in accordance with the equation

SBR_{normalized}=SBR/(d*cos(arcsin(2×/d))),

d denoting the diameter of the blank 2, and x denoting the distance of the measurement position in the X-direction from the center of the blank 2, which are linked to the angle φ at the measurement position MP with reference to the Y-direction by the following relationship:

φ=arcsin(2×/d).

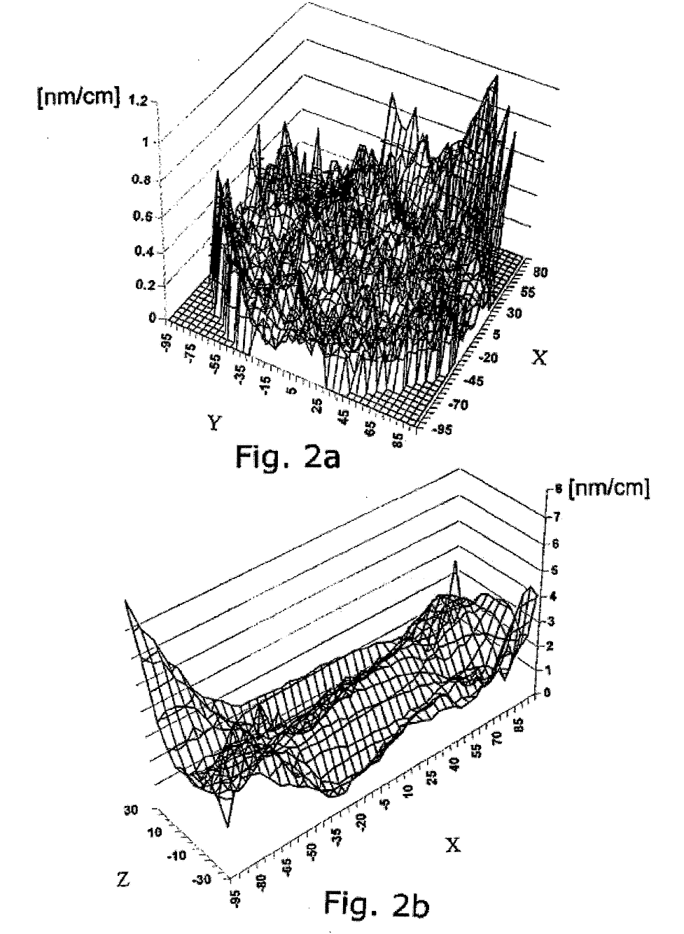

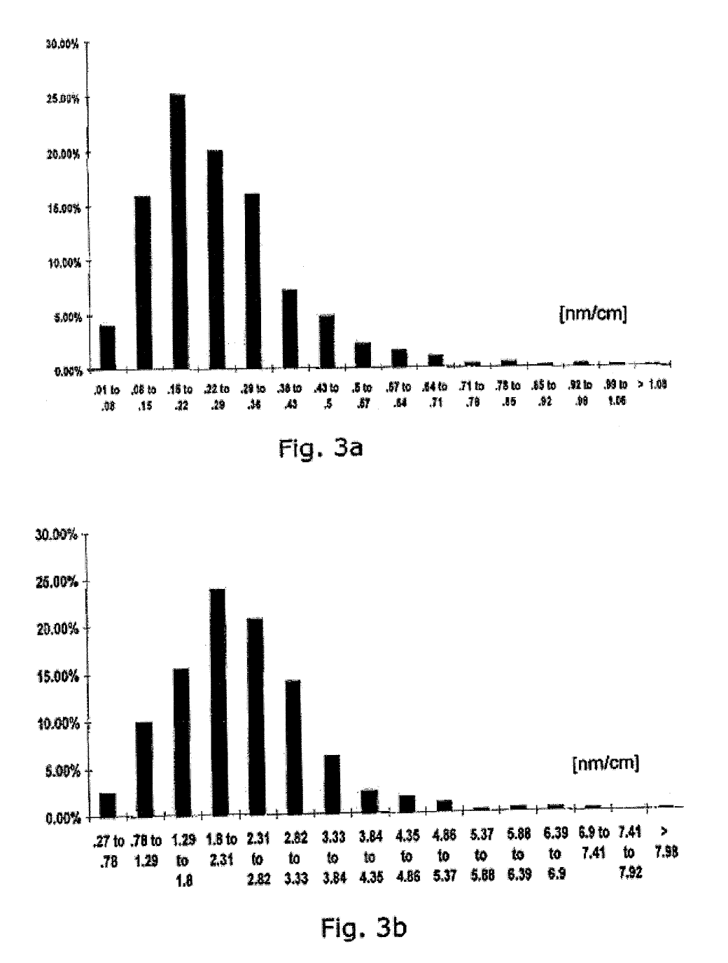

Account having been taken of the abovedescribed directions, a non-axial distribution of the stress birefringence is obtained, as shown in FIG. 2b (in nm/cm, since the diameter d of the blank 2 was measured in cm) (here, the diameter d is approximately 20 cm). FIG. 3b shows a statistical evaluation of the birefringence distribution of FIG. 2b with the aid of a histogram of the measured birefringence (in %) within the limits between 0 nm/cm and approximately 8 nm/cm, in accordance with the minimum and maximum measured birefringence values, respectively.

The distribution and the histogram of the birefringence in the axial measuring direction (Z-direction) parallel to the axis of symmetry S of the blank 2, which are shown in FIG. 2a and FIG. 3a, respectively, can likewise be determined with the aid of the measuring apparatus 1 which has for this purpose a further polarimeter 7a, 8a, compare FIG. 1b, which serves for irradiating the blank 2 at an end-face measuring position SP by means of an axial measuring light beam 9a. The end-face measuring position SP can be varied in this case by using the movement device 10 to displace the axial measuring light beam 9a in the XY-plane of the XYZ coordinate system, in order to scan the blank 2 at its entire end face 2b. It goes without saying that use can also be made to this end, if appropriate, of the polarimeter 7, 8 of FIG. 1a if this polarimeter can, by means of the movement device 10, or manually, be brought out of the measurement position shown in FIG. 1a into the one shown in FIG. 1b.

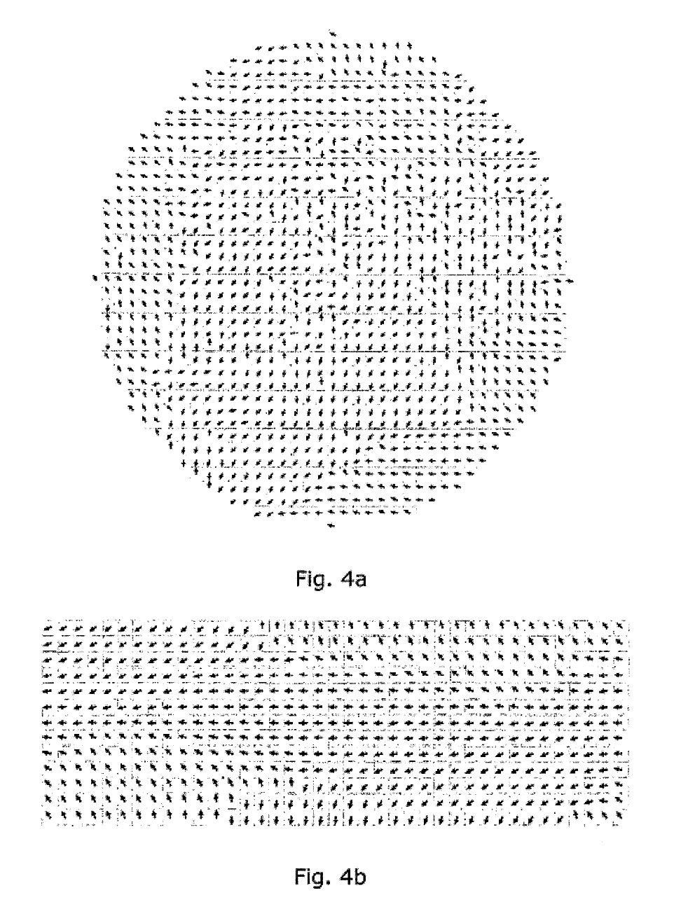

The three-dimensional distribution of the stress birefringence in the blank 2 can be determined by a combination of the measured data of the stress birefringence in the non-axial and axial directions (FIGS. 2a, 2b). This information can be used to estimate the polarization behavior of the lens element to be fabricated from the blank 2, and to calculate the overall influence of said lens element on the polarization behavior of the system. FIGS. 4a,b show the orientation of the fast axis of the birefringence in the blank 2 axially (FIG. 4a) and non-axially (FIG. 4b). It is likewise possible to use the orientation of the fast axis to derive important information for the correction of the retardation of a lens produced from the blank 2, if the blank 2 is being used for producing lenses.

In order for the measuring errors to be kept as small as possible in the case of the above-described measurement of the birefringence, edge effects, which can occur at the lateral surface 2a and the end faces 2b of the blank 2, should be minimized. For this purpose, the refractive index nₒ of the optical material of the blank 2, and the refractive index n_{I} of the immersion fluid 5 should be tuned to one another, i.e. said refractive indices should lie as close as possible to one another at the measuring wavelength λ_{M}. In the above example, the refractive index nₒ of calcium fluoride is approximately 1.43288 at 633 nm, while the refractive index n_{I} of the solvent mixture used as immersion fluid 5 is approximately 1.44. It goes without saying that the polarimeter 7, 8 can also be operated with other measuring wavelengths by selecting another measuring light source. In particular, the measuring wavelength can also correspond to the operating wavelength λ_{B} of an optical element, fabricated from the blank 2, in an optical arrangement, in particular a projection exposure machine for microlithography, that is to say it can hold true that: λ_{B}=λ_{M}=193 nm for example. It is necessary here to use a suitable immersion fluid which corresponds as well as possible to the refractive index nₒ of calcium fluoride of approximately 1.50195 at 193 nm. By way of example, decahydro-2-trifluoromethyl-2,3,3-trifluoro-1,2:5,8-dimethano-naphthalene, whose refractive index n_{I} is approximately 1.55, and which has an extinction coefficient of approximately 1.2 l/cm, is suitable for this purpose, and so a high transmission is ensured. Furthermore, the measured values must be corrected by the intrinsic birefringence of the optical material of the blank, in the present case of calcium fluoride, at 193 nm, in order to obtain the contribution of the stress birefringence in the blank 2.

By measuring the birefringence of the blank 2 in the axial and non-axial directions, the optical material or the blank 2 can be qualified as a lens with regard to its later polarization properties. In particular, blanks whose (three-dimensional) birefringence distribution does not correspond to a prescribed specification can be rejected such that no additional costs arise from the fabrication of an optical element from a blank which does not have the quality desired for a prescribed use, for example use in an illumination system, operated with polarized radiation, of a lithography system. The measurement of the distribution of the birefringence in the non-axial direction is particularly advantageous when such an optical element is operated in a light passage direction, in the case of which the penetrating beams have an angular deviation from the axial direction of more than 5°, and the blank 2 has a thickness D of approximately 40 mm or more.

The above description of the preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

1. Method for spatially resolved measurement of the birefringence distribution of a cylindrically symmetrical blank made from an optical material transparent to at least one wavelength λ_{B} between 180 nm and 650 nm, comprising:
irradiating the blank, arranged in a container with an immersion fluid, at a jacket-side measurement position (MP) with a measuring light beam which extends in a measuring direction (Y) in a given relation to the axis of symmetry (S) of the blank, and
varying the jacket-side measurement position (MP) by moving the measuring light beam and the blank relative to one another in two directions (X, Z) perpendicular to the measuring direction (Y) in performing the spatially resolved measurement of the non-axial birefringence distribution of the blank.

2. Method according to claim 1, wherein the optical material is transparent to a wavelength λ_{B} of 193 nm, and wherein the given relation is perpendicular.

3. Method according to claim 1, further comprising: irradiating the blank at an end-face measurement position (SP) with a measuring light beam, which extends in an axial measuring direction (Z) parallel to the axis of symmetry (S) of the blank, and
varying the end-face measurement position (SP) by moving the measuring light beam and the blank relative to one another in two directions (X, Y) perpendicular to the axial measuring direction (Z) in performing the spatially resolved measurement of the axial birefringence distribution of the blank.

4. Method according to claim 1, further comprising:
selecting the measuring light beam to have a measuring wavelength (λ_{M}) of less than 250 nm, and
selecting the immersion fluid to have an extinction coefficient of less than 2×l/cm at the measuring wavelength (λ_{M}).

5. Method according to claim 1, further comprising: selecting the refractive index (n_{I}) of the immersion fluid to correspond to the refractive index (nₒ) of the optical material of the blank at the measuring wavelength (λ_{M}).

6. Method according to claim 1, further comprising: determining the orientation of the fast axis of the birefringence in the blank from the birefringence distribution.

7. Method according to claim 1, further comprising: prior to said irradiating the blank, determining the influence of the immersion fluid and of the container on the measurement of the birefringence of the blank for correction purposes.

8. Method according to claim 1, wherein: for determining the non-axial birefringence of the blank, the path length covered in the blank by the measuring light beam is determined at the respective jacket-side measurement position (MP).

9. Method according to claim 1, wherein, during the relative movement, the blank is moved in common with the container.

10. Method according to claim 1, wherein the measuring light beam is produced by a measuring light source and is detected by a detector, and wherein, during the relative movement, the measuring light source is moved in common with the detector.

11. Method according to claim 1, further comprising: selecting calcium fluoride as optical material of the blank.

12. Measuring apparatus for spatially resolved measurement of a birefringence distribution, comprising:
a container filled with an immersion fluid,
a blank made from an optical material transparent to at least one wavelength λ_{B} between 180 nm and 650 nm,
a polarimeter arranged to irradiate the blank with a measuring light beam at a jacket-side measurement position (MP), a measuring direction (Y) of the polarimeter extending in a given relation to the axis of symmetry (S) of the blank, and
a movement device arranged to move the polarimeter and the container relative to one another in two directions (X, Z) perpendicular to the measuring direction (Y), thereby varying the jacket-side measurement position (MP) for the spatially resolved measurement of the non-axial birefringence distribution of the blank.

13. Measuring apparatus according to claim 12, wherein the optical material is transparent to a wavelength λ_{B} of 193 nm, wherein the given relation is perpendicular, and wherein the container is a cuvette.

14. Measuring apparatus according to claim 12, wherein the movement device (10) is configured to move at least one of the polarimeter and a further polarimeter and to move the container relative to one another in two directions (X, Y) perpendicular to the axis of symmetry (S) of the blank.

15. Measuring apparatus according to claim 12, wherein the refractive index (n_{I}) of the immersion fluid corresponds to the refractive index (nₒ) of the optical material of the blank at the measuring wavelength (λ_{M}).

16. Measuring apparatus according to claim 12, wherein the polarimeter has a measuring light source producing the measuring light beam at a measuring wavelength (λ_{M}) of less than 250 nm as well as a detector detecting the measuring light beam.

17. Measuring apparatus according to claim 12, wherein the immersion fluid has an extinction coefficient of less than 2.0×l/cm at the measuring wavelength (λ_{M}).

18. Measuring apparatus according to claim 12, wherein the blank has a thickness (D) of at least 40 mm.
